(19) United States
(12) Patent Application Publication
(10) Pub. No.: US 2025/0361915 A1
(43) Pub. Date: Nov. 27, 2025

(54) TENSIONING MODULE FOR AN ELECTROMECHANICAL WHEEL BRAKE AND ELECTROMECHANICAL BRAKE DEVICE

(71) Applicant: Continental Automotive Technologies GmbH, Hannover (DE)

(72) Inventors: I-Che Chiang, Frankfurt am Main (DE); Anja Klimt, Frankfurt am Main (DE); Sabrina Schulze-Demasi, Großmehring (DE); Sven Rückert, Reinheim (DE); Marco Besier, Bad Schwalbach (DE); Mathias Haag, Darmstadt (DE); Dirk Pauly, Frankfurt am Main (DE)

(73) Assignee: Continental Automotive Technologies GmbH, Hannover (DE)

(21) Appl. No.: 19/218,234

(22) Filed: May 24, 2025

(30) Foreign Application Priority Data
May 24, 2024 (DE) 10 2024 204 809.7
Jun. 3, 2024 (DE) 10 2024 205 113.6
Dec. 23, 2024 (DE) 10 2024 212 285.8

(51) Int. Cl. F16D 65/18; B60T 13/74; F16D 125/40

(52) U.S. Cl. CPC F16D 65/18; B60T 13/746; F16D 2125/40

(57) ABSTRACT

A tensioning module for an electromechanical wheel brake and to an electromechanical brake device comprises a stop bearing washer; an axial bearing; and a ball screw drive. The the ball screw drive comprises a spindle and a nut. The stop bearing washer is arranged at an axial end of a radial extension of the spindle, An anti-rotation safeguard arranged between the nut and a housing surrounding the tensioning module. The tensioning module is used to move a brake piston in the electromechanically operable wheel brake of a motor vehicle.

### TECHNICAL FIELD

A tensioning module for an electromechanical wheel brake and to an electromechanical brake device. The tensioning module is used to move a brake piston in the electromechanically operable wheel brake of a motor vehicle.

### BACKGROUND

Electromechanical wheel brakes (“EMB”) are currently being developed for modern motor vehicles, which are also to be used as service brakes. These wheel brakes afford a number of utilities over conventional, hydraulically actuated wheel brakes. For example, there is no longer any need for a complex hydraulics system, and an electromechanical wheel brake also takes up less space.

Electromechanical wheel brakes of this kind typically have an electronic drive unit which interacts with a mechanism or a gear mechanism. A brake unit can then be arranged on the output side, and this can comprise, for example, a brake piston and a friction lining which can be pressed onto a rotating friction partner by means of translational movement. It is thereby possible to bring about deceleration during operation.

To this end, the drive unit typically comprises at least one electric motor which has a correspondingly high power density. The mechanical connection to the friction brake can then be established by means of at least the gear mechanism. In addition to factors such as efficiency and rigidity, above all the mechanical design, the installation space requirement and the transmission characteristic determine the possible applications of the wheel brake.

Various mechanisms are known for converting the rotational motion of the electric motor into the required translational or linear motion. A known mechanism for this is, for example, a ball screw drive (BSD). The ball screw drive affords the possibility of linear power transmission. Known electromechanical brake devices with a ball screw drive as rotation/translation converters, however, are of relatively long overall design to bridge comparatively longer distances, also with regard to wear compensation, which can be challenging with regard to the installation situation and the space requirement.

The installation space of electromechanically actuated parking brake units is admittedly less important, with the result that a relatively large axial overall length of the entire tensioning module is possible.

If a tensioning module of this type, however, similar to an electric parking brake as described above, is to be used for example for an electromechanically actuable disk brake as a service brake, a larger extent in the axial direction may not be helpful. This can lead to challenges with such electromechanically actuable wheel brakes, for example when they are to be integrated into the front axles of a motor vehicle.

The steering lock at the front axles for example makes it suitable to have as little axial overall length as possible in order to be able to integrate electromechanically actuable disk brakes into today's car front axle installation spaces. The axial overall length of electromechanically actuable wheel brakes is therefore of value.

Another aspect is that parking brakes transmit lower torques than service brakes. This can result in the fact that antirotation safeguard means of ball screw drive components, such as between a piston and a brake lining, and/or seals, such as those known from parking brakes, cannot easily be transferred to service brakes.

Therefore a tensioning module, for example for an electromechanical actuable wheel brake, which at least mitigates the abovementioned challenges or does not have them is desirable. The tensioning module should be able to interact with a ball screw drive.

Furthermore, the electromechanically actuable wheel brake should be able to be used as a service brake.

In addition, one objective is to reduce the axial overall length of the electromechanically actuable wheel brake.

It is still expedient here if the number of components can be reduced. In addition, modularity in the construction and in the individual components is also useful, as well as mountability of the individual parts and components.

### SUMMARY

This object is achieved by a tensioning module, an electromechanical brake device for a motor vehicle, and a motor vehicle as disclosed herein.

In a first aspect, a tensioning module, for example for an electromechanical brake device for a motor vehicle comprises a ball screw drive, a stop bearing washer, and an axial bearing, wherein the ball screw comprises a spindle and a nut, wherein the stop bearing washer is arranged at an axial end of a radial extension of the spindle, and an antirotation safeguard means is provided between the nut and a housing surrounding the tensioning module.

In a further aspect, also relates to an electromechanical brake device, for example an electromechanically actuable wheel brake, comprising such a tensioning module.

Finally, the embodiments also relate to a motor vehicle, comprising at least one electromechanical brake device having at least one tensioning module as described above.

A motor vehicle may mean for example, a vehicle having axles, wherein at least one of these axles can comprise steerably guided wheels and, furthermore, the drive of the wheels of at least one axle can be adapted in a wheel-specific manner.

The electromechanically actuable wheel brakes of the electromechanical brake device can be designed as electromechanical disk brakes, for example as a caliper brake, to be specific for front axle and for rear axle applications in motor vehicles.

It is possible that the tensioning module can also be used with other wheel brakes, for example drum brakes. A combination with a parking brake is also possible.

The electromechanical brake device can comprise an electric motor with a correspondingly designed gear mechanism, for driving the spindle. This can generate a drive torque and transfer it from the electric motor to the spindle via a suitable gear mechanism.

The configurations of an electromechanical brake device described below are shown by way of example using the example of an electromechanical disk brake for setting defined application forces. A transfer to an electromechanical drum brake for setting defined spreading forces or braking torques is possible for a person skilled in the art.

With respect to the brake device, the application direction, that is to say an axial direction in which the piston can be moved to produce a brake force, is hereinafter referred to as the piston side or on the piston side, whereas the opposite direction, and therefore the release direction in which the drive unit can be located in an extension of the spindle, is also referred to as the drive side of the brake device or on the drive side.

The electromechanical actuable disk brake can be designed in such a way that an application force can be generated by means of the electric motor and a gear mechanism. In this context, the application force refers to the force with which the brake linings are pressed against the brake disk. Depending on the embodiment and control concept, the actuation of the electromechanical disk brakes can be such that either a specified, defined tensioning force or a specified, defined brake torque can be set in accordance with the deceleration demand requested.

The tensioning module can comprise a housing or caliper housing in the style of common designs for disk brake housings or can be integrated into such a caliper housing, for example a floating caliper brake or a sliding caliper brake. The caliper housing can also be designed here as a multi-piston unit or multi-piston caliper and can comprise more than one tensioning module, for example two tensioning modules. In this way, the caliper housing can be designed, for example, as a two-piston sliding caliper. The caliper housing can comprise corresponding brackets for mounting friction linings for the realization of a disk brake.

Accordingly, a tensioning module of the aforementioned type is provided, wherein the spindle, the nut, the stop bearing washer and/or the axial bearing can be formed as separate components.

The tensioning module can further comprise a piston which is configured such that it is also axially displaceable by an axial movement of the nut, and wherein the stop bearing washer can be arranged on that side of the spindle which lies opposite the piston. This enables a compact design in the axial direction.

According to one embodiment, the spindle can be mounted in the housing by the axial bearing. The axial bearing can be arranged in such a way that it can absorb axial forces, which can arise during clamping, and can transfer them to the housing. To this end, the spindle can have a radially projecting, for example annular stop which makes it possible to transfer the axial forces first of all to the stop bearing washer and from this to the axial bearing.

According to one embodiment, the spindle can have a piston-side threaded portion and a drive-side drive portion, wherein the drive portion can have a smaller cross-sectional area than the threaded portion. In this way, the annular stop can be formed, which provides the piston-side stop surface for the stop bearing washer. The transition from the drive portion to the threaded portion therefore represents the radial extension of the spindle.

The application force can be applied by means of the nut and the spindle, which thus interact as a rotation-translation converter. Based on a drive torque of an electric motor, which can preferably be transmitted to the spindle via suitably designed gear units, the piston can be moved by means of the nut in an axial movement relative to the housing. In this way, for instance in the case of a disk brake, friction linings can be moved and pressed against a rotating element, e.g. a brake disk, in order to generate a predetermined brake torque.

The piston can be connected here to the housing by an elastic ring element, wherein the elastic ring element can be configured to be so elastically deformable that a relative axial displacement of the housing and piston is made possible. In this way, a gap or intermediate space which arises between the housing and piston can be sealed against the ingress of particles or other substances.

The stop bearing washer can be disk-shaped or ring-shaped with a through hole in order for it to be possible for it to be plugged onto the spindle. This enables cost-effective separate production and easy assembly.

For a fixed connection to the spindle for conjoint rotation, the stop bearing washer can have a spline system in the region of the through hole. The spline system can be designed, for example, as an internal spline system in the stop bearing washer, wherein the spindle can then have an external spline system of diametrically opposed configuration with an accurate fit. Furthermore, the stop bearing washer can comprise a centering collar on the end face pointing toward the piston, which can facilitate the fitting to the spindle with an accurate fit. Alternatively or in addition, a press connection or an integrally joined connection can also be provided, but it must be noted that the torque to be transmitted can be great.

Finally, the stop bearing washer can comprise a radially projecting shoulder according to one embodiment. As a result, an end stop may be provided, by way of which an end position of the actuator can be detected.

Such a tensioning module allows an antirotation safeguard means and a tangential rotation stop to be integrated into a single component or into a single assembly. This allows the number of components required to be reduced.

The tensioning module can further comprise an antirotation safeguard means, for example designed as a separate antirotation safeguard element. This enables mounting capability with modularity at the same time. The antirotation safeguard element can engage with the nut and piston and provide a antirotation safeguard means for the nut relative to the piston. According to one development, it can also be provided that the antirotation safeguard element further engages with the housing. In this way, an antirotation safeguard means can be provided for both the nut and the piston in relation to the housing.

The antirotation safeguard element can have at least one of the following features. It can be formed as a disk-shaped or ring-shaped element with a continuous opening or a through hole, in order for it to be possible for it to be plugged onto the nut and connected to the nut fixedly for conjoint rotation. The fixed connection for conjoint rotation can also be provided via a spline system as described above, or via, for example, corresponding flattened portions. Alternatively or in addition, a press connection or an integrally joined connection can also be provided.

According to one embodiment, the antirotation safeguard element can comprise a radially protruding attachment which can engage into a recess or groove of the piston to bring about an antirotation safeguard means.

According to a further embodiment, the antirotation safeguard element can comprise a pin which may protrude axially from the end face on the side opposite the piston. The pin can be arranged to this end on the radially projecting attachment and can provide a stop for the radially projecting shoulder of the stop bearing washer in a predetermined rotational position of the stop bearing washer.

The antirotation safeguard means can realize at least two functions in this manner. Thus, an antirotation safeguard means of the nut with respect to the piston and/or with respect to the surrounding housing can be provided. A tangential rotary stop of the spindle and the nut can also be provided.

The proposed design of the tensioning module can ensure reliable and safe operation of the tensioning module and an electromechanically actuable wheel brake equipped with the tensioning module.

The angle of rotation of the motor and the spindle may be assigned a unique axial piston stroke here, and thus a reliable function and control of the piston stroke can be made possible with the help of electronics designed to this end and suitable software.

The electronics and the software can be provided in a drive unit which can be connected to the housing and can thus be assigned to the wheel brake. However, it is also possible to store these functions, for instance, in a central vehicle controller.

Further details arise from the description of the illustrated exemplary embodiments and the attached claims.

### BRIEF DESCRIPTION OF THE DRAWINGS

In the drawings:

FIG. 1 shows a sectional view of a tensioning module according to a first embodiment,

FIG. 2 shows an outside view of the tensioning module from FIG. 1,

FIG. 3 shows a stop bearing washer of the tensioning module from FIG. 1 in an oblique view,

FIG. 4 shows an outside view of the tensioning module from FIG. 1 without the stop bearing washer of FIGS. 2 and 3,

FIG. 5 shows a ball screw drive of the tensioning module in accordance with FIG. 4 without a housing and a more visible antirotation safeguard means,

FIG. 6 shows a ball screw drive of the tensioning module in accordance with FIG. 5 without an antirotation safeguard means,

FIG. 7 shows a sectional view of a tensioning module according to a further embodiment,

FIG. 8 shows an outside view of the tensioning module from FIG. 7,

FIG. 9 shows a stop bearing washer of the tensioning module from FIG. 7,

FIG. 10 shows an outside view of the tensioning module without the stop bearing washer of FIGS. 8 and 9,

FIG. 11 shows a ball screw drive of the tensioning module in accordance with FIG. 10 without a housing and a more visible antirotation safeguard means, and

FIG. 12 shows a ball screw drive of the tensioning module in accordance with FIG. 10 without an antirotation safeguard means.

### DETAILED DESCRIPTION

In the following detailed description of embodiments, for the sake of clarity, the same designations denote substantially identical parts in or on these embodiments. However, for better clarification, the embodiments illustrated in the figures are not always drawn to scale. For reasons of clarity, only those elements which are relevant for the embodiment of the approach are illustrated here.

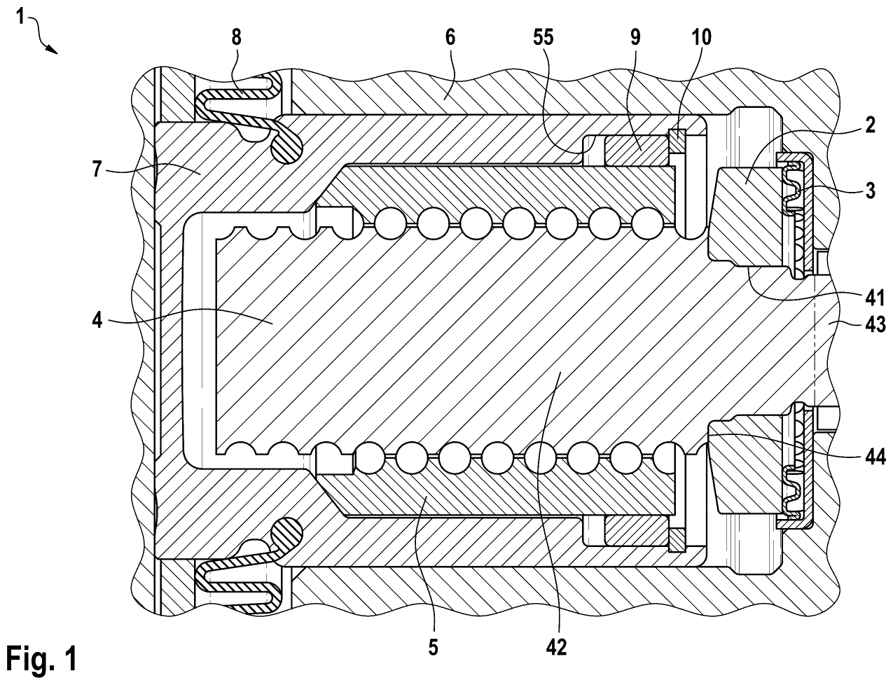

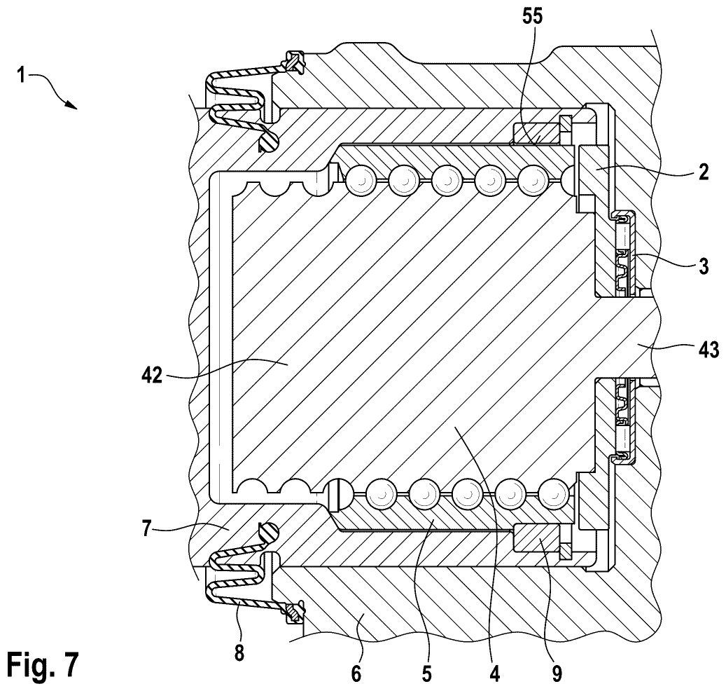

FIGS. 1 and 7 show possible embodiments of the tensioning module 1 in a sectional view. The tensioning module 1 is suitable for an electromechanical brake device for a motor vehicle and comprises a ball screw drive, a stop bearing washer 2, and an axial bearing 3, wherein the ball screw drive comprises a spindle 4 and a nut 5, wherein the stop bearing washer 2 is arranged at an axial end of a radial extension of the spindle 4, and wherein an antirotation safeguard means is provided between the nut 5 and a housing 6 surrounding the tensioning module 1.

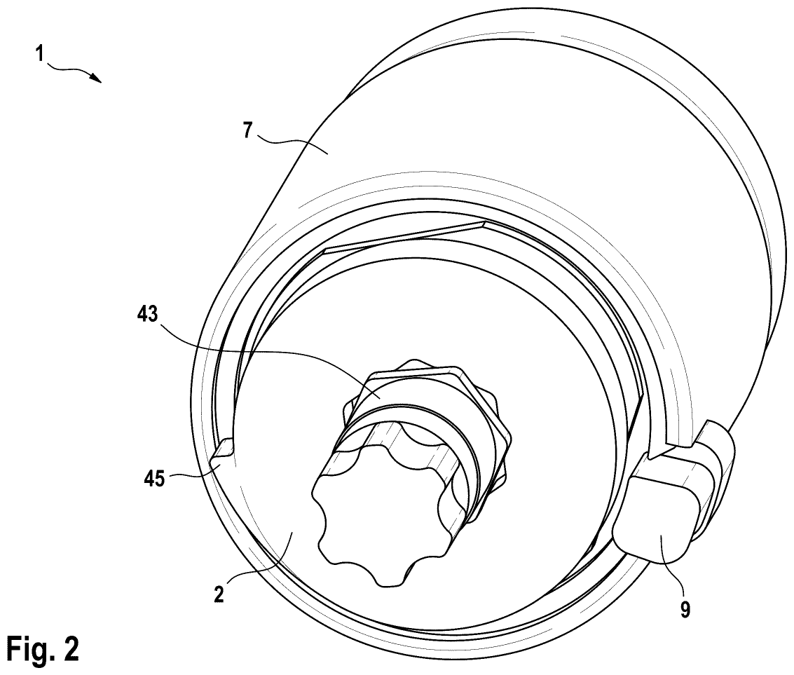

The housing 6 is designed for the mounting and securing of the tensioning module 1. In the tensioning module 1 shown in FIG. 2 in a plan view, various components, for example the surrounding housing 6, are not shown for the sake of clarity alone.

An electromechanical brake device, for example an electromechanically actuable wheel brake, with a tensioning module 1 is preferably here as a disk brake. The electromechanically actuable wheel brake may comprise an electric motor for driving the spindle 4.

Furthermore, a motor vehicle, comprises at least one electromechanical brake device having at least one tensioning module 1.

The rotation-translation converter of the tensioning module 1 is designed as a ball screw drive with a nut 5, a spindle 4 and balls (not shown in the view of FIG. 1) which run in corresponding grooves of the nut 5 and/or the spindle 4. In the tensioning module 1 shown, the spindle 4, the nut 5, the stop bearing washer 2 and the axial bearing 3 are formed as separate components, which enables easy production of these components from correspondingly selected suitable materials.

The tensioning module 1 in the embodiment shown further comprises a piston 7. The piston 7 is arranged linearly or axially movably relative to the housing 6. The tensioning module 1 can comprise a drive unit (not shown in greater detail) with the electric motor and the gear mechanism, in order to generate a drive torque with which the spindle 4 can be subjected to a torque during operation.

Based on the drive torque of the drive unit, the piston 7 can be moved in an axial movement along its axis of rotation relative to the housing 6. The nut 5 is provided to transfer the force component to the piston 7 by means of an axial movement. In this way, the piston 7 can press friction linings (not shown) against a brake disk (not shown) to generate a predetermined brake torque or a predetermined application force for the wheel brake.

The piston 7 in the illustrated configuration is connected to the housing 6 by an elastic ring element 8, which is not fully shown, wherein the elastic ring element 8 is so elastically deformable that a relative axial displacement of the housing 6 and piston 7 is possible.

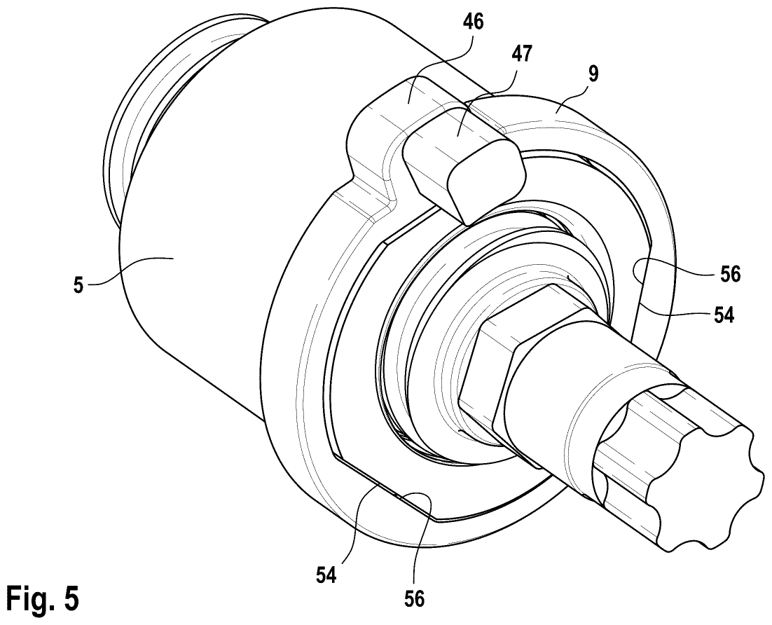

The tensioning module 1 comprises an antirotation safeguard means which comprises an antirotation safeguard element 9. The antirotation safeguard element 9 is shown in FIG. 1. The antirotation safeguard element 9 is discussed in depth in connection with FIG. 5 further below.

The tensioning module 1 further comprises an axial securing ring 10 which is mounted in the piston 7. The securing ring 10 serves to be able to pull the piston 7 actively in the release direction (to the right in FIG. 1) with the aid of the nut 5.

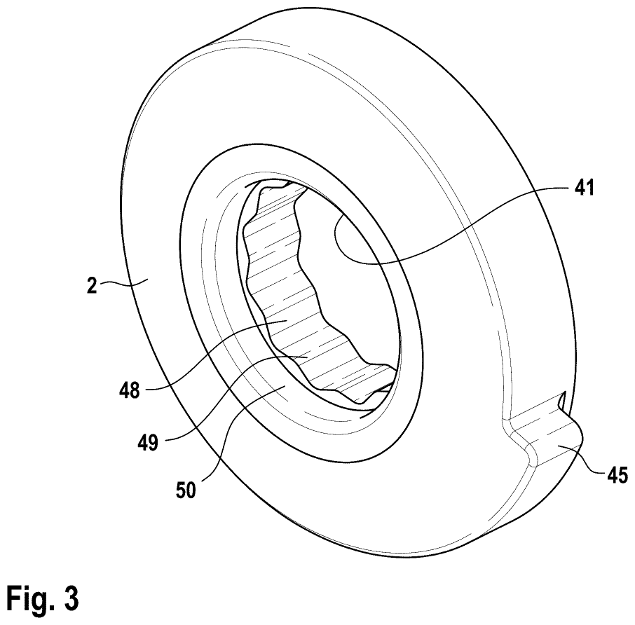

The tensioning module 1 further comprises the stop bearing washer 2 and the axial bearing 3. FIG. 3 shows the stop bearing washer 2 in one embodiment in an oblique view.

The spindle 4 is supported by the axial bearing 3 in the housing 6. The axial bearing 3 is arranged in such a way that it can absorb axial forces, which can arise during clamping, and can transfer them to the housing 6. The axial bearing 3 can be designed, for example, as a single or double row cylindrical roller bearing as shown in FIG. 1.

The spindle 4 has a radial, annular stop 44, which runs around in a ring-shaped manner, for the stop bearing washer 2, which makes it possible to transfer the axial forces occurring during application first of all to the stop bearing washer 2 and from this to the axial bearing 3. The spindle 4 comprises a piston-side threaded portion 42 and a drive-side drive portion 43, wherein the drive portion 43 has a smaller cross-sectional area or a smaller diameter than the threaded portion 42. In this way, the ring-shaped stop 44 is formed, which provides the piston-side stop surface for the stop bearing washer 2 or the radial extension.

The axial bearing 3 can, as shown in the embodiment in FIG. 1, have an outer diameter which approximately corresponds to the outer diameter of the stop bearing washer 2. This makes it possible that, for example, a tangential outer region of the stop bearing washer 2 is axially supported, whereby stability can be achieved.

The stop bearing washer 2 is of disk-shaped or ring-shaped form with a through hole 41, through which the spindle 4, for example the drive portion 43, is guided. The stop bearing washer 2 is designed to be able to be plugged directly onto the spindle 4 in the axial direction. In order to enable a fixed connection to the spindle 4 for conjoint rotation, a spline system 48 is provided in the region of the through hole. The corresponding portion of the spindle 4 is of matching design with respect to this with a corresponding counterspline system.

In the embodiment shown, it is an external spline system 51 of the spindle 4, which interacts with the internal spline system of the stop bearing washer 2 and establishes a positively locking connection. Alternatively or in addition, a press connection or an integrally joined connection is also possible. In this way, the drive torque can be safely transferred between the spindle 4 and the stop bearing washer 2.

FIG. 3 shows the spline system 48 of the stop bearing washer 2 as an internal spline system. In the embodiment shown, the spline system 48 is configured with 12 teeth 49 or 12 points. This enables axial plugging onto the spindle 4, which is configured in the embodiment with a hexagonal external spline system in the corresponding portion of the spindle 4. Due to the design of the internal spline system with 12 teeth, axial plugging on affords more adjustment possibilities than with a design of the internal spline system with only 6 teeth, for the assembly.

The stop bearing washer 2 further comprises a centering collar 50 on the end face pointing toward the piston for mounting with an accurate fit.

Furthermore, the stop bearing washer 2 is formed with a radially projecting shoulder 45 which provides a tangential rotary stop of the stop bearing washer 2 and the nut 5 and/or the antirotation safeguard element 9.

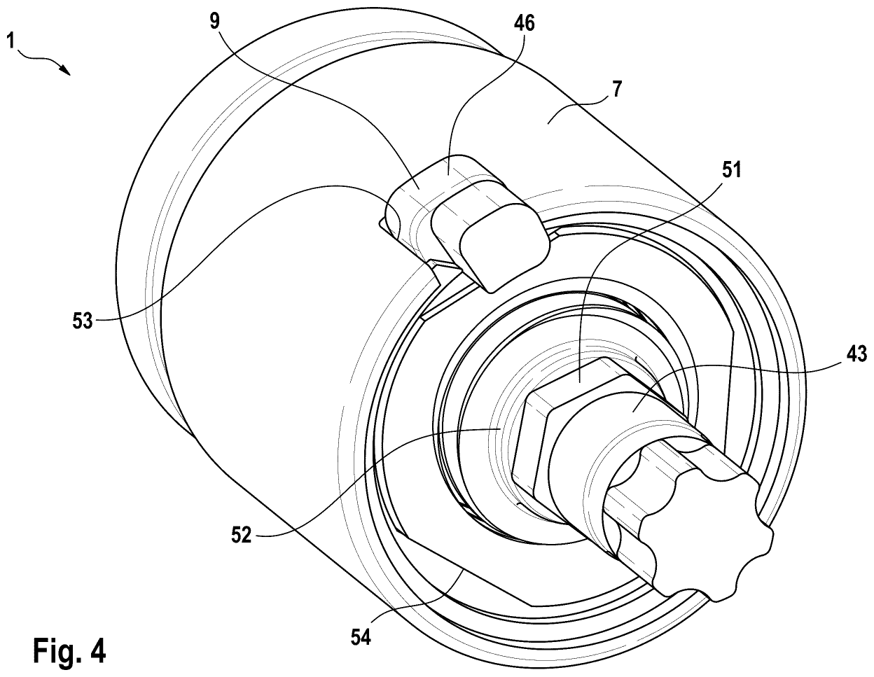

FIG. 4 shows an outside view of a tensioning module 1 without the stop bearing washer 2 of FIGS. 2 and 3. The outer contour of the spindle 4 can be easily recognized as a hexagon which is of diametrically opposed design with an accurate fit with respect to the inner contour of the stop bearing washer 2 and onto which the stop bearing washer 2 is axially plugged. Furthermore, a centering means 52 can be seen, which is seated in the mounted position on the centering collar 50 of the stop bearing washer 2.

The stop bearing washer 2 combines the following functions in a single component: it forms the running surface for the axial bearing 3 or the rolling bodies of the axial bearing 3, and it forms the tangential rotary stop between the spindle 4 and the nut 5.

FIG. 5 shows the ball screw drive of a tensioning module 1 in accordance with FIG. 4 without a caliper housing 6, with the result that the antirotation safeguard means is more visible. The antirotation safeguard means is designed as a ring-shaped antirotation safeguard element 9. The antirotation safeguard element 9 is seated in this embodiment, as can also be seen from FIG. 1, on the nut 5. The piston 7 comprises a recess 55, which runs around in a ring-shaped manner, for receiving the antirotation safeguard element 9, with the result that the antirotation safeguard element 9 is received by the piston 7 and is therefore arranged predominantly within the piston 7. This region of the piston comprises a further recess 53 which will also be discussed further below.

The antirotation safeguard element 9 can be plugged onto the nut 5 in the axial direction. In the embodiment shown in FIG. 5, an outer contour of the nut 5 with three flattened portions 54 in the example is provided to this end. The inner contour of the antirotation safeguard element 9 is of diametrically opposed design with an accurate fit with the corresponding flattened portion 56 to this end, with the result that a positively locking connection is produced between the nut 5 and the antirotation safeguard element 9.

The antirotation safeguard element 9 comprises a radially projecting attachment 46. This attachment 46 can be received by the recess 53 of the piston 7, as can be seen clearly in FIG. 4. In FIG. 1, this attachment 46 cannot be seen. Thus, an antirotation safeguard means can be produced between the nut 4 and the piston 7.

In the illustrated embodiment the attachment 46 is furthermore of protruding design with respect to the outer shell surface of the piston 5 and is therefore guided through the corresponding portion of the piston 5, in order for it to be possible for it to be guided further into the housing 6. Thus, the attachment 46 protrudes radially with respect to the shell surface of the piston 5.

The attachment 46 protrudes here far enough that it can engage into a recess of the housing 6, for instance a groove of diametrically opposed design with an accurate fit. The attachment can then be guided in this groove in the housing 6 in the case of an axial movement of the piston 7, and in this way can realize the antirotation safeguard means between the nut 5 and the housing 6.

The attachment 46 further comprises, at its radial end a projection or pin 47 which has a substantially axial orientation.

The pin 47 protrudes axially with respect to the antirotation safeguard element 9 or the end face of the antirotation safeguard element 9 in a direction opposed to the piston 7. In the embodiment shown, it does not protrude beyond the attachment 46 in the radial direction, in order to likewise be guided in the groove of the housing 6.

This embodiment therefore combines the following functions: the pin 47 forms the antirotation safeguard means of the nut 5 in the housing 6. To this end, the housing 6 may be provided with a groove of diametrically opposed design with an accurate fit.

The pin 47 forms a rotary stop, against which the stop bearing washer 2, for example the shoulder 45, can come into contact tangentially. This forms the rear stop of the tensioning module 1.

In the embodiment shown, the antirotation safeguard element 9 with attachment 46 and pin 47 are of monolithic or single-part design. However, multi-part embodiments are also conceivable and possible, for example embodiments in which the pin 47 is designed as a separate bolt and is plugged into the attachment 46.

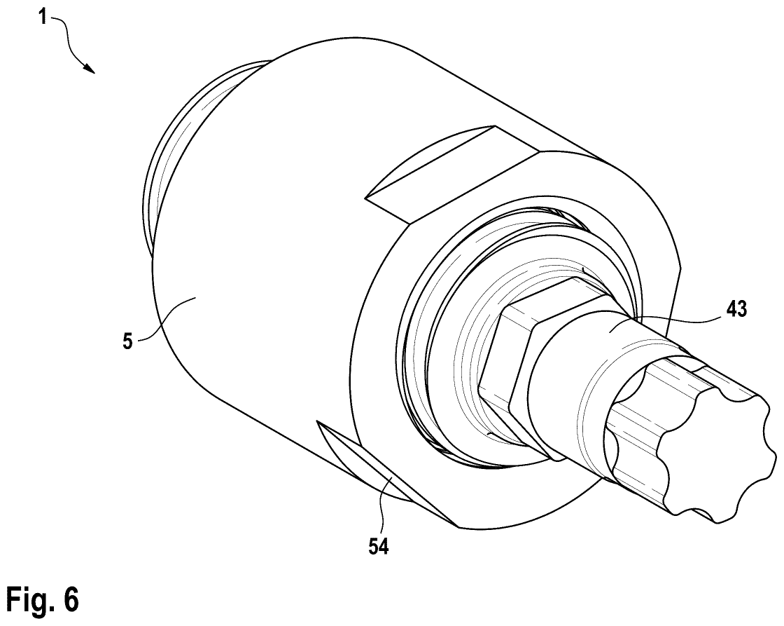

FIG. 6 shows a ball screw drive of a tensioning module 1 in accordance with FIG. 5 without an antirotation safeguard means. In this illustration, the three flattened portions 54 on the outer contour of the nut 5 can be seen, onto which the antirotation safeguard element 9 is placed axially.

In the embodiment shown in FIG. 7 of a tensioning module 1 the stop bearing washer 2 is of narrower design in the axial direction. As a result, installation space in the axial direction can again be saved.

In the embodiment shown here, the diameter of the threaded portion 42 of the spindle 4 is selected to be very large, for example in relation to the diameter of the drive portion 43. In FIG. 7, the diameter of the threaded portion 42 is more than twice as large as the diameter of the drive portion 43 and is even about three times as large. This makes it possible for the fixed connection for conjoint rotation between the spindle 4 and the stop bearing washer 2 to be of correspondingly different configuration, with the result that the stop bearing washer 2 can be of shorter design as viewed in the axial direction, which entails shortening of the length of the tensioning module 1.

The background is that the stop bearing washer 2 is configured on the piston-side end face with a spline system 59, into which diametrically opposed flattened portions 57 with an accurate fit of the spindle 4 engage. In this way, a positively locking and thus fixed connection for conjoint rotation is created.

The diameter of the piston-side spline system 59 is greater than the diameter of the axial bearing 3, wherein, in the case of the spline system 59, the outer circular path enclosing the tips of the teeth 58 is meant. Therefore, the stop bearing washer 2 can be of thinner configuration than in the embodiment of FIG. 1, in which the stop bearing washer 2 is of thicker configuration in the axial direction in order to close the force flow from the stop 44 to the axial bearing 3. In other words, in the embodiment of FIG. 1, the stop bearing washer 2 is of thicker configuration in the axial direction, because the diameter of the axial bearing 3 is greater than the diameter of the threaded portion 42 of the spindle 4.

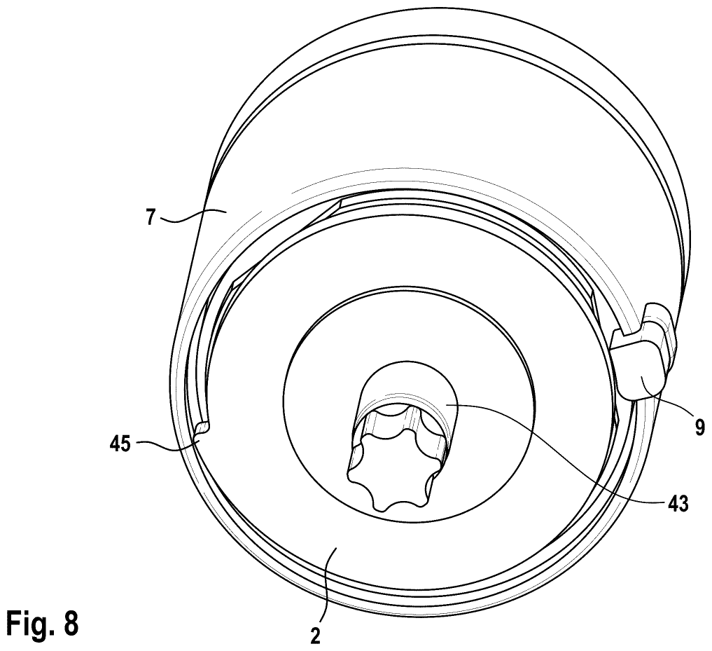

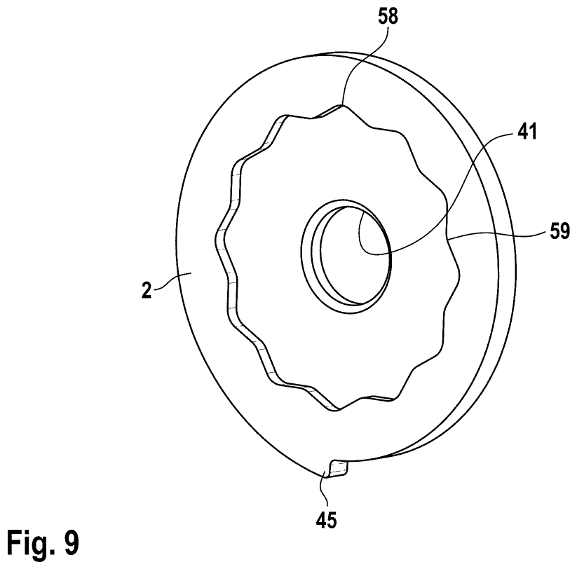

FIG. 8 shows an outside view of the tensioning module 1 from FIG. 7, and FIG. 9 shows the stop bearing washer 2 of the tensioning module 1 from FIG. 7.

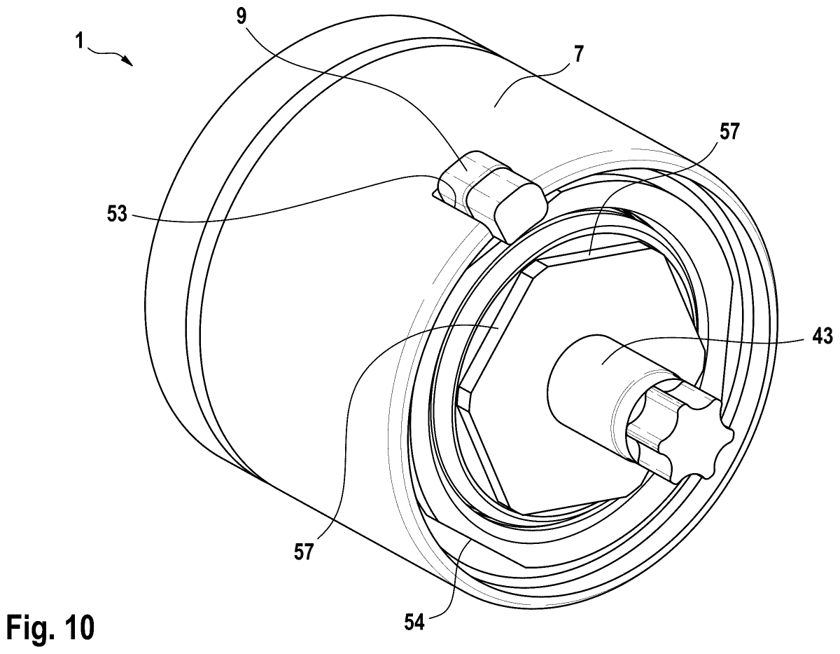

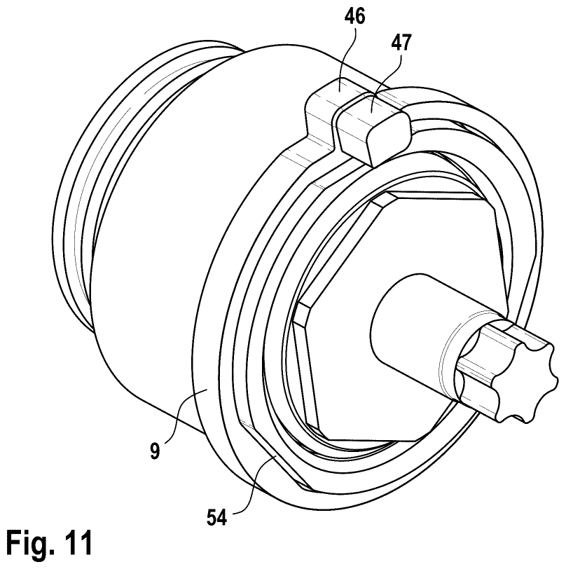

Furthermore, FIG. 10 shows an outside view of the tensioning module 1 without the stop bearing washer 2 of FIGS. 8 and 9, and FIG. 11 shows the ball screw drive of the tensioning module 1 according to FIG. 10 without a housing and a more visible antirotation safeguard means.

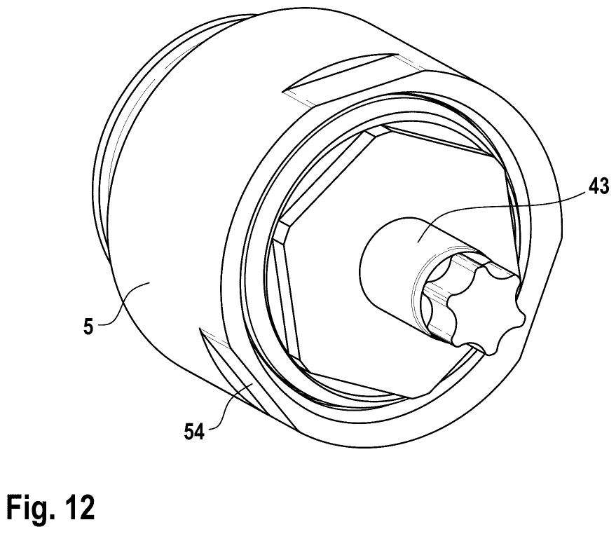

Finally, FIG. 12 shows the ball screw drive of the tensioning module 1 in accordance with FIG. 10 without an antirotation safeguard means.

1. A tensioning module for an electromechanical brake device for a motor vehicle comprising:
a stop bearing washer;
an axial bearing;
a ball screw drive, wherein the ball screw drive comprises a spindle and a nut, and wherein the stop bearing washer is arranged at an axial end of a radial extension of the spindle, and
an anti-rotation safeguard is arranged between the nut and a housing surrounding the tensioning module.

2. The tensioning module as claimed in claim 1, wherein the tensioning module comprises a piston which is axially displaceable by an axial movement of the nut, and wherein the stop bearing washer is arranged on a side of the spindle which lies opposite the piston.

3. The tensioning module as claimed in claim 1, wherein the spindle is supported by the axial bearing in the housing.

4. The tensioning module as claimed in claim 1, wherein the piston is connected by an elastic ring element to the housing, wherein the elastic ring element is elastically deformable such that a relative axial displacement of the housing and piston is possible.

5. The tensioning module as claimed in claim 1, wherein the spindle comprises a threaded portion and a drive portion, wherein the drive portion has a smaller cross-sectional area than the threaded portion.

6. The tensioning module as claimed in claim 1, wherein the spindle comprises a stop which runs around in an annular manner for the stop bearing washer.

7. The tensioning module as claimed in claim 1, wherein the stop bearing washer has at least one of an annular shape with a through hole, and a radially protruding shoulder.

8. The tensioning module as claimed in claim 1, wherein the stop bearing washer comprises a centering collar on the end face pointing toward the piston.

9. The tensioning module as claimed in claim 1, wherein the stop bearing washer comprises an internal spline system in the region of the through hole.

10. The tensioning module as claimed in claim 9, wherein the internal spline system has twelve teeth and wherein the corresponding drive portion of the spindle has a matching counterspline system for forming a positively locking connection therebetween.

11. The tensioning module as claimed in claim 1, wherein the stop bearing washer comprises a spline system on a piston-side end face, and wherein the spindle has flattened portions which are diametrically opposed with to the spline system for forming a positively locking connection therebetween.

12. The tensioning module as claimed claim 1, wherein the antirotation safeguard comprises a antirotation safeguard element which engages with the nut and the piston and provides an antirotation safeguard of the nut relative to the piston.

13. The tensioning module as claimed in claim 12, wherein the antirotation safeguard element further engages with the housing and provides an antirotation safeguard of the nut relative to the housing.

14. The tensioning module as claimed in claim 12, wherein the antirotation safeguard element has at least one of: a ring-shape, a radially protruding attachment, a pin which protrudes axially from an end face in the opposite direction to the piston, and is arranged on the attachment.

15. The tensioning module as claimed in claim 1, wherein the stop bearing washer provides at least one of a running surface for the axial bearing, and a tangential rotary stop between the spindle and the nut.

16. The tensioning module as claimed in claim 1, wherein the spindle, the stop bearing washer and the axial bearing are formed as separate components.

17. An electromechanical brake device comprising:
an electromechanically operable disk brake, comprising
a tensioning module comprising:
a stop bearing washer;
an axial bearing;
a ball screw drive, wherein the ball screw drive comprises a spindle and a nut, and wherein the stop bearing washer is arranged at an axial end of a radial extension of the spindle, and
an anti-rotation safeguard arranged between the nut and a housing surrounding the tensioning module; and
an electric motor connected to the spindle for driving the spindle.

18. A motor vehicle, comprising:
an electromechanically operable disk brake, comprising:
an electromechanically operable disk brake, comprising
a tensioning module comprising:
a stop bearing washer;
an axial bearing;
a ball screw drive, wherein the ball screw drive comprises a spindle and a nut, and wherein the stop bearing washer is arranged at an axial end of a radial extension of the spindle, and
an anti-rotation safeguard arranged between the nut and a housing surrounding the tensioning module; and
an electric motor connected to the spindle for driving the spindle.
